(19) United States
(12) Patent Application Publication
(10) Pub. No.: US 2002/0046875 A1
(43) Pub. Date: Apr. 25, 2002

(54) Insulation of stator windings with shrink-on sleeves

(76) Inventors: Thomas Baumann, Wettingen (CH); Joerg Oesterheld, Birmenstorf (CH); Rico Gasparini, Rieden (CH)

Correspondence Address: BURNS DOANE SWECKER & MATHIS L L P, POST OFFICE BOX 1404, ALEXANDRIA, VA, 22313-1404, US

(21) Appl. No.: 09/852,788

(22) Filed: May 11, 2001

(30) Foreign Application Priority Data
May 12, 2000 (DE) 100 23 204.3

(51) Int. Cl. H01B 17/00

(52) U.S. Cl. 174/137 R

(57) ABSTRACT

Described is a method for the production of an insulated stator winding for rotating electrical machines, in particular, direct current machines and alternating current machines, whereby an insulated stator winding is produced that ensures adequate insulation over the intended life span of the electrical machine. The insulated stator winding is constructed of at least one electrically conductive conductor bar (2) with an essentially rectangular cross-section, whereby at least one electrically insulating shrink-on sleeve (64) with an essentially rectangular cross-section is applied to the periphery of the conductor bar (2) and then shrunk onto it.

### FIELD OF TECHNOLOGY

The invention relates to a method for insulating stator windings for rotating electrical machines, in particular, direct current machines and alternating current machines.

### STATE OF THE ART

In general, such electrical machines are provided with a stator and a rotor in order to convert mechanical energy into electrical energy (i.e., a generator) or, vice versa, to convert electrical energy into mechanical energy (i.e., an electric motor). Depending on the operating status of the electrical machine, voltages are generated in the conductors of the stator windings. This means that the conductors of the stator windings must be appropriately insulated in order to avoid a short circuit.

Stator windings in electrical machines can be constructed in different ways. It is possible to bundle several individual conductors that are insulated against one another and to provide the conductor bundle created in this manner, often called a conductor bar, with a so-called main insulation. To produce the stator windings, several conductor bars are connected with each other at their frontal faces. This connection can be made, for example, with a metal plate to which both the respective insulated individual conductors of the first conductor bar as well as the respective insulated individual conductors of the second conductor bar are connected in a conductive manner. The individual conductors of the conductor bar are therefore not insulated from each other in the area of the metal plate.

Alternatively to bundling the individual conductors into conductor bars, a long, insulated individual conductor is wound to a flat, oval coil that is called an original coil form, or “fish.” In a subsequent process, the so-called spreading, the original coil forms are transformed into their final shape and built into the stator.

With both of the above-described manufacturing techniques, both round and rectangular individual conductors can be used. The conductor bars or original coil forms produced from several individual conductors for the stator windings again may have round or rectangular cross-sections. The invention at hand preferably looks at conductor bars or original coil forms with a rectangular cross-section that were made from rectangular individual conductors. The conductor bars may be manufactured either as Roebel transpositions, i.e., with individual conductors twisted around each other, or not as Roebel transpositions, i.e., with untwisted individual conductors that extend parallel to each other.

According to the state of the art, mica paper that has been reinforced with a glass fabric carrier for mechanical reasons, is usually wound tape-like around the conductor in order to insulate the stator windings (e.g., conductor bars, original coil forms, coils). The wound conductor, which may also be shaped after being taped, is then impregnated with a hardening resin, resulting in a duroplastic, non-meltable insulation. Also known are mica-containing insulations with a thermoplastic matrix that are also applied to the conductor in the form of a tape, such as, for example, asphalt, shellac (Brown Boveri Review Vol. 57, p. 15: R. Schuler: “Insulation Systems for High-Voltage Rotating Machines”), polysulfone and polyether ether ketone (DE 43 44044 A1). These insulations can be plastically reshaped when the melting temperature of the matrix is exceeded.

The insulations of stator windings that have been applied by winding have the disadvantage that their manufacture is time- and cost-intensive. In this context, special mention should be made of the winding process and impregnation process since they cannot be significantly accelerated any further because of the physical properties of the mica paper and impregnation resin. This manufacturing process is particularly prone to defects especially in the case of thick insulations, if the mica paper adapts insufficiently to the stator winding. In particular, an insufficient adjustment of the winding machine after wrapping the stator winding may result in wrinkles and tears in the mica paper, for example, because of a too steep or flat angle between the mica paper and the conductor, or because of an unsuitable static or dynamic tensile force acting on the mica paper during the wrapping. An excessive tape application may also result in overlaps that prevent uniform impregnation of the insulation in the impregnation tool. This may create a locally or generally defective insulation with reduced short-term or long-term stability. This significantly reduces the life span of such insulations for stator windings.

In addition, manufacturing processes for encasing conductor bundles are known from cable technology, whereby conductor bundles with a round cross-section are always encased with a thermoplast or with elastomers in an extrusion process. Document U.S. Pat. No. 5,650,031, which is related to the same subject matter as WO 97/11831, describes such a process for insulating stator windings in which the stator winding is passed through a central bore of an extruder. The stator winding, which has a complex shape, is hereby encased simultaneously with an extruded thermoplastic material at each side of the complex form, especially by co-extrusion.

Also known from cable technology are polymeric insulations applied to the cables using a hot shrink-on technique. This relates to prefabricated sleeves with a round cross-section of curing thermoplasts, elastomers, polyvinylidene fluoride, PVC, silicone elastomer or Teflon. After fabrication, these materials are stretched in their warm state and cooled. Once cooled, the material retains its stretched shape. This is accomplished, for example, because crystalline centers that fix the stretched macromolecules are formed. After repeated heating beyond the crystalline melting point, the crystalline zones are dissolved, whereby the macromolecules return to their unstretched state, and the insulation is in this way shrunk on. Also known are cold shrink-on sleeves that are mechanically stretched in their cold state. In the stretched state, these sleeves are pulled over a support structure that holds the sleeves permanently in the stretched state. Once the sleeves have been pushed and fixed over the components to be insulated, the support structure is removed in a suitable manner, for example, by pulling a spiral, perforated support structure out. But such shrink-on techniques cannot be used for stator windings with a rectangular cross-section since the sleeves with their round cross-section easily tear along the edges of the rectangular conductors, either immediately after shrinking or after being strained briefly while the electrical machine is operated, because of the thermal and mechanical stresses.

Even while the stator windings are being manufactured, especially during the bending and handling of the conductors, particularly during installation into the stator, the insulation must be able to bear a significant high mechanical stress which could damage the insulation of the stator windings. The insulation of the stator winding conductors is also exposed to a combined stress during operation of the electrical machine. On the one hand, the insulation is dielectrically stressed between the conductor, to which a high voltage is applied, and the stator, by a resulting electrical field. On the other hand, the heat generated in the conductor exposes the insulation to a thermal alternating stress, whereby a high temperature gradient is present in the insulation while the machine passes through the respective operating states. Because the materials involved expand differently, mechanical alternating stresses also occur. This results both in a shearing stress of the bond between conductor and insulation and a risk of abrasion at the interface between insulation and slot wall of the stator. Because of these high stresses, the insulation of the stator windings may tear, resulting in a short circuit. Consequently, the entire electrical machine will fail, and the repair will be time- and cost-intensive.

### DESCRIPTION OF THE INVENTION

This is the starting point for the invention. The invention, as characterized in the claims, is based on the objective of creating a process for insulating stator windings for rotating electrical machines, whereby insulated stator windings are produced that ensure the insulation of the stator winding over the intended life span of the electrical machine.

This objective is realized by the method according to the characteristics of independent claim 1.

The method according to the invention for producing an insulated stator winding for rotating electrical machines, in particular, direct current machines and alternating current machines, where said insulated stator winding is constructed of at least one electrically conductive conductor bar with an essentially rectangular cross-section, whereby at least one electrically insulating shrink-on sleeve with an essentially rectangular cross-section is applied to the periphery of the conductor bar and shrunk onto the conductor bar, has the advantage that the shrinking-on of an insulated stator winding produces an insulated stator winding that ensures an advantageous insulation. This is the case particularly because the electrically insulating shrink-on sleeve always hugs the conductor bar at each point without forming wrinkles or voids, whereby the edges of the shrink-on sleeve come to rest against the edges of the conductor bar. This prevents a potential tearing of the shrink-on sleeve at the edges. The prefabrication of the shrink-on sleeve with the known shaping processes (extrusion, injection molding) also ensures, when combined with testing of the electrical components prior to assembly, an optimum insulation quality. Because of its defined thickness, the shrink-on sleeve also encloses the conductor bar in the required manner uniformly at each point of its periphery in order to ensure a suitable electrical and mechanical insulation. This ensures that the insulated stator winding has sufficient insulation over the intended life span of the electrical machine.

Because there are only a few, simple process steps, an insulated stator winding is manufactured in a time- and cost-efficient manner, whereby both straight and pre-bent conductor bars can be insulated, so that the conductor bar can be bent into its final shape either prior to or after the insulation is applied.

It was found to be advantageous that the shrink-on sleeve is mechanically dilated in its cold state and applied to the outer periphery of a support device, in particular, a support sleeve, before the support sleeve that has been surrounded with the shrink-on sleeve is pulled over the conductor bar, whereby the support sleeve is larger than the conductor in order to facilitate the application of the shrink-on sleeve onto the conductor bar.

The contact of the shrink-on sleeve with the conductor bar is ensured in that, after application of the support sleeve surrounded by the shrink-on sleeve, the support sleeve between the shrink-on sleeve and the conductor bar is removed, in particular by opening the shrink-on sleeve helically, so that the shrink-on sleeve contracts around the conductor bar.

Alternatively, the contact of the shrink-on sleeve with the conductor bar can be achieved in that the support sleeve contains a meltable polymer, whereby, after the support sleeve surrounded by the shrink-on sleeve has been applied to the conductor bar, the support sleeve is brought to melting by introducing heat, so that the dilated shrink-on sleeve is able to relax and starts to hug the conductor bar. The molten support sleeve hereby advantageously functions as an adhesive and sealing mass. If the support sleeve is constructed in a conductive manner, the molten support sleeve also assumes the function of the internal corona shielding.

It has also been found to be advantageous to use a shrink-on sleeve of a heat-shrinking material that is mechanically dilated in the warm state and is cooled in this dilated state. Specific material properties ensure that part of this dilation is maintained in the cold state. In this state, the shrink-on sleeve is pulled over the conductor bar, whereby the shrink-on sleeve is then shrunk, under application of heat, onto the conductor bar so that no further devices are necessary for insulation.

Alternatively, the assembly may take place by using compressed air for dilating the sleeve.

It is also advantageous that the shrink-on sleeve is constructed of several layers with different properties around the periphery of the conductor bar, whereby the layers provide the internal corona shielding, the main insulation, the slot corona shielding, and the yoke corona shielding.

A preferred mechanical connection between the conductor bar and the shrink-on sleeve can be achieved if the shrink-on sleeve has at its contact surfaces with the conductor bar a thermally stable adhesive. This also prevents the formation of voids, so that the thermal conductivity is improved and electrical void discharges are avoided, which is especially an advantage for variations in which no internal corona shielding is used.

If the shrink-on sleeve is constructed of an extruded elastomer sleeve, it can be constructed continuously, on the one hand, in an advantageous manner, and, on the other hand, can be adjusted to different bar geometries. The elastomer insulation furthermore prevents tearing of the insulation during the bending. The present invention uses the high elasticity of the elastomer while maintaining the ability to withstand high thermal and electrical stresses. For higher thermal stresses a silicone elastomer is used advantageously.

In a particularly preferred method, the conductor bars are only brought into their final shape after being encased with the elastomer. The bending of the involutes greatly stretches the applied insulation. The use of elastomer according to the invention is hereby found to be particularly advantageous, since it reduces or even completely avoids mechanical, electrical or thermal injury to the insulation that is being stressed by bending.

### BRIEF DESCRIPTION OF DRAWINGS

The invention is described in more detail below with reference to the drawings, using exemplary embodiments.

FIG. 1a shows a cross-section through an insulated stator winding with conductor bar and shrink-on sleeve;

FIG. 1b shows a cross-section through an insulated stator winding with conductor bar, support sleeve, and shrink-on sleeve (prior to shrinking);

FIG. 2 shows a partial section of the side view of FIG. 1b; and,

FIG. 3 shows a device for bending the insulated conductor bars.

The figures only show the elements and components essential for understanding the invention. The shown methods and devices according to the invention therefore can be supplemented in many ways or can be modified in a manner obvious to one skilled in the art, without abandoning or changing the concept of the invention.

### WAYS OF EXECUTING THE INVENTION

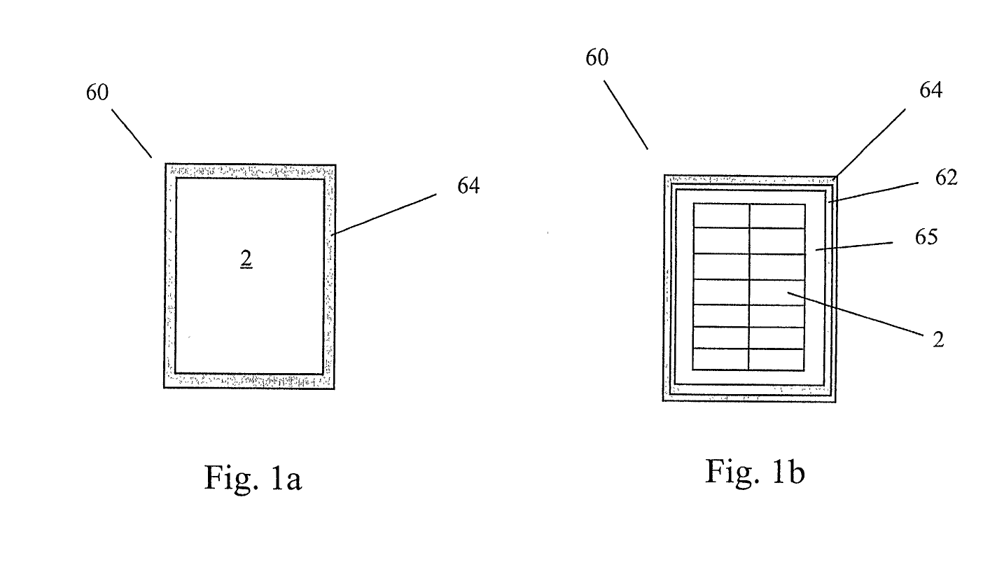

FIG. 1a shows a cross-section through an insulated stator winding 60. A rectangular conductor bar 2 is hereby surrounded by a shrink-on sleeve 64. The conductor bars themselves usually are constructed of a bundle of individual, insulated conductors. In Roebel-transposed conductor bars, the individual conductors are in part twisted around each other, while in non-Roebel-transposed conductor bars the individual conductors extend parallel to each other without twisting. In the invention, conductor bars with individual conductors that have a round cross-section can be used. However, the application of the method according to the invention for conductor bars with individual conductors with a rectangular cross-section is particularly advantageous. When using rectangular cross-sections, the advantages of the invention are also obtained when the cross-sections of the individual conductors and/or of the conductor bar deviate slightly from the rectangular shape. If the conductor bar is constructed of individual conductors, it is advantageous that these are temporarily connected to each other in order to enable a uniform and cavity-free encasing of the conductor bar with the main insulation, for example, by temporarily bonding the individual conductors with an elastic material or an adhesive with low mechanical strength against shearing forces, so that later bending is not impeded. Alternatively, an adhesive that loses its bending power during moderate heating (e.g., before bending) and thus promotes the bending process.

The shrink-on sleeve 64 shown in FIG. 1a preferably is manufactured from a hot-shrinking material. The material is stretched in its warm state and is then kept partially or completely in its stretched state through a subsequent cooling process without subjecting the sleeve to any further mechanical influences. During heating, the sleeve returns to its rubber-elastic behavior and shrinks onto the bar when subjected to heat.

FIG. 1b shows a cross-section through an insulated stator winding 60 that is constructed of an electrically conductive, potentially Roebel-transposed conductor bar 2 that has a rectangular cross-section and is encased by a support sleeve 62 with an extra width 65 in relation to the conductor cross-section, and which supports the electrically insulating shrink-on sleeve 64 with its rectangular cross-section, also with an extra width in relation to the conductor cross-section, in order to permit an easy assembly, i.e., a sliding-on of the sleeve. It is also preferred here that both the internal cross-section as well as the external cross-section of the shrink-on sleeve are constructed rectangular. The shrink-on sleeve shown here is preferably manufactured from cold-shrinking material.

In both of the embodiments shown in FIG. 1a and b, the shrink-on sleeve can be manufactured from a hot-shrinking or cold-shrinking material. The shrink-on sleeve preferably has a rectangular cross-section that matches with the cross-section proportions of the conductor bar, whereby the internal cross-section of the completely shrunk sleeve should be smaller than the conductor cross-section in order to ensure optimum contact with the conductor cross-section. It is especially preferred that both the internal and external cross-section of the shrink-on sleeve are rectangular.

It is preferred that an elastomer is used as a material for the shrink-on sleeve. The elastomer is characterized by high elasticity. It also has a high electrical and thermal stability. In particular for thermally highly stressed machines it is preferred that silicone elastomers are used. Especially the advantageous use of elastomer (in contrast to other materials) permits the use of injection molding processes and fulfills the high requirements for material resistance and mechanical flexibility. The elastomers may be cold- or hot-curing types. The curing for cold-curing types is initiated, for example, by mixing two components, whereby one of the components contains a curing agent. In the case of hot-curing types, the elastomer can be heated already in the injection mold or the extruder. During the extrusion, the curing can also be initiated after the exit from the extruder, for example, with hot air.

The material properties of the main insulation can be adjusted in such a way by adding active (e.g., silicic acid) and passive (e.g., quartz sand) fillers that they fulfill the respective mechanical requirements of the electrical machines into which the stator windings provided with the main insulation are installed.

In some applications, it is preferred that the conductor bars are provided with slot corona shielding and termination (yoke corona shielding) as well, if applicable, with an internal corona shielding. The internal corona shielding of a stator winding is usually a conductive material layer located between main insulation and conductor bar. It enables a defined potential coating around the conductor bar and prevents electrical discharges that can be caused by voids between the conductor bar and the main insulation. The slot or external corona shielding of a stator winding usually is a conductive material layer located between the main insulation and the stator slot. The external corona shielding, which again creates a defined potential layer, is supposed to prevent electrical discharges that can be caused, for example, by varying distances of the high potential insulated conductor bar from the grounded stator nut. The direction (yoke corona shielding) usually prevents electrical discharges at the slot exit of a conductor bar. Options for applying such protective layers within the scope of this invention include, for example, conductive or semi-conductive elastomer-based finishes, suitable tapes (possibly self-fusing), which can be cured by irradiation or heat. Alternatively, cold- or heat-shrink-on sleeves (for example, for bars) or cuffs (for example, for coils) can be used. When using shrink-on sleeves or cuffs for the internal corona shielding, these may be provided advantageously on their inside with a flowable, plastic material to fill the voids on the surface of the conductor bar. This is basically also possible for an external corona shielding.

In another preferred embodiment of the method, internal corona shielding, main insulation, and/or external corona shielding are applied in the form of several shrink-on sleeves or one shrink-on sleeve consisting of several layers.

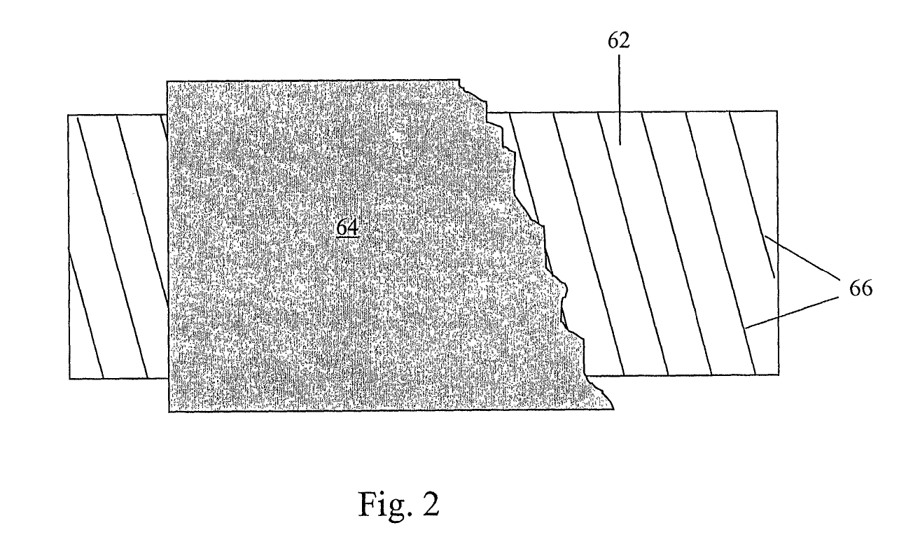

FIG. 2 shows the insulated stator winding 60, whereby the shrink-on sleeve 64 is shown in a partial section view. The shrink-on sleeve 64 surrounds the support sleeve 62 that is provided with helically arranged perforations 66 for removing the support sleeve.

In order to produce the insulated stator winding 60, the shrink-on sleeve 64 is mechanically dilated in its cold state and is applied in this dilated state around the outer periphery of the support sleeve 62 that holds the shrink-on sleeve 64 in the stretched state. Then the support sleeve 62 that is surrounded by the shrink-on sleeve 64 is pulled over the conductor bar 2 and, as required, is fixed so that the periphery of the conductor bar 2 is surrounded by the support sleeve 62. After applying the support sleeve 62 that is surrounded by the shrink-on sleeve 64 onto the conductor bar 2, the support sleeve 62 between the shrink-on sleeve 64 and the conductor bar 2 is removed by helically opening the support sleeve 62 along helically arranged perforations 66. The stretched shrink-on sleeve 64 then relaxes and then hugs the conductor bar 2. The conductor bar 2 insulated in this manner is bent with a bending device into the shape suitable for the stator, whereby the insulated conductor bar 2 can also be bent directly in the stator if it is sufficiently flexible.

Alternatively, the support sleeve 62 is not constructed as a perforated spiral but consists of a meltable polymer, for example, a thermoplast or duroplast, in the bi-stage state. By introducing heat, the melting of the support sleeve is initiated so that the stretched sleeve is able to relax and hugs the conductor. After solidifying, the molten polymer also functions as an adhesive mass or sealing mass for filling any voids. If the polymer is conductive, it is also able to assume the function of the internal corona shielding.

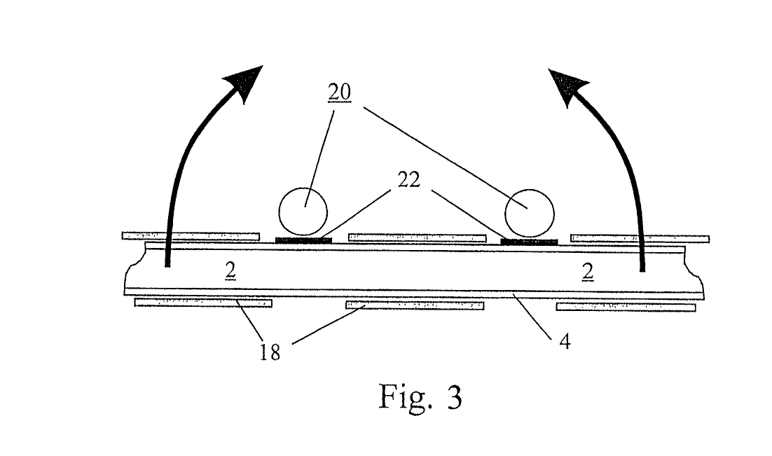

FIG. 3 shows a bending device that has been modified from the state of the art. The insulated conductor bars are placed into the gripping jaws 18 of the bending device and are brought there into their final shape by moving the gripping jaws 18 in relation to the radial tools 20. Between the radial tools 20 and the insulating layer 4 of the conductor bar 2 that has been produced from the shrink-on sleeve 64, a protective layer 22 is provided that distributes the pressure generated at the radial tools over the surface and in this way prevents an excessive pinching of the insulation layer 4. The uniformly distributed mechanical stress on the elastomer insulation layer prevents damage to the insulation layer. The bending of the involute causes very high tensile forces in the insulation layer 4 that can be absorbed by the elastomer used for the shrink-on sleeve 64 without damaging it, however.

If the conductor bar is constructed of a bundle of individual conductors, the bending of conductor bars already provided with the main insulation causes both a relative movement of the individual conductors against each other as well as a relative movement of the individual conductors at the surface of the conductor bar against the main insulation. It is advantageous that the interface between conductor bar and main insulation has properties that enable a shifting of the individual conductors against the main insulation with reduced friction. This may be achieved, for example, by treating the conductor bar with separating agents. The occurrence of gaps due to this relative movement at the interface to the conductor is meaningless if an internal corona shielding connected tightly with the main insulation is used in this area. Without internal corona shielding, the shifting is, in most cases, uncritical because the field is reduced in the bend area (following the termination).

When using an internal corona shielding, it is advantageous that it has good adhesion in relation to the main insulation, but has a lesser adhesion in relation to the surface of the conductor bar. This is preferably achieved in that insulation and corona shielding are based on the same chemical materials (chemical bond), while the internal corona shielding and wire lacquering each have a different material base with, preferably, little affinity. Separating agents may be able to increase this effect. The conductor bars themselves are preferably not Roebel-transposed in the area where the later bending takes place.

As is obvious from the previous description, many modifications and changes of the embodiment described here can be made without exceeding the scope of the invention.

### LIST OF REFERENCE NUMBERS

2 Conductor bar

4 Insulation layer

18 Gripping jaws

20 Radial tool

22 Protective layer

60 Insulated stator winding

62 Support sleeve

64 Shrink-on sleeve

65 Extra width

66 Perforation

1. Method for producing an insulated stator winding for rotating electrical machines, in particular, direct current machines and alternating current machines, where said insulated stator winding is constructed of at least one electrically conductive conductor bar with a rectangular cross-section, whereby at least one electrically insulating shrink-on sleeve with a rectangular cross-section is applied to the periphery of the conductor bar and shrunk onto the conductor bar.

2. Method as claimed in claim 1, characterized in that the shrink-on sleeve is mechanically dilated in its cold state and applied around the outer periphery of a support sleeve before the support sleeve surrounded by the shrink-on sleeve is pulled over the conductor bar.

3. Method as claimed in claim 2, characterized in that after the support sleeve surrounded by the shrink-on sleeve is applied to the conductor bar, the support sleeve between the shrink-on sleeve and the conductor bar is removed, in particular, by a helical opening of the support sleeve.

4. Method as claimed in claim 2, characterized in that the support sleeve is a meltable, in particular conductive polymer, whereby after application of the support sleeve surrounded by the shrink-on sleeve onto the conductor bar the melting of the support sleeve is initiated by introducing heat.

5. Method as claimed in claim 1, characterized in that a shrink-on sleeve of a hot-shrinking material is used and is shrunk under the effect of heat onto the conductor bar.

6. Method as claimed in claim 1, characterized in that the shrink-on sleeve is pulled in the cold state over the conductor bar, whereby the sleeve is dilated with compressed air.

7. Method as claimed in one of the previous claims, characterized in that the shrink-on sleeve is constructed of several radially superimposed layers with different properties.

8. Method as claimed in claim 7, characterized in that the shrink-on sleeve is produced by co-extrusion, blow molding, or injection molding.

9. Method as claimed in one of the previous claims, characterized in that a plurality of shrink-on sleeves and/or sleeves with different properties are applied around the periphery of the conductor bar.

10. Method as claimed in one of the previous claims, characterized in that the shrink-on sleeve is provided at its contact surfaces with the conductor bar with a thermally stable adhesive.

11. Method as claimed in one of the previous claims, characterized in that the shrink-on sleeve is constructed of an extruded elastomer.

12. Method as claimed in one of the previous claims, characterized in that the conductor bar surrounded by the shrink-on sleeve is bent with a bending device into the shape suitable for the stator.

13. Method as claimed in one of the previous claims, whereby conduct or bars consisting of individual conductors are used, whereby the individual conductors preferably have a rectangular cross-section.

14. Method as claimed in claim 13, whereby the individual conductors are temporarily connected with each other.

15. Method as claimed in one of claims 13 or 14, whereby the conductor bars are not Roebel-transposed in the area of the involute.

16. Shrink-on sleeve for encasing conductor bars 2, whereby the shrink-on sleeve (64) has a rectangular internal cross-section.

17. Shrink-on sleeve as claimed in claim 16, whereby the shrink-on sleeve (64) is placed around a support sleeve (62).
